(19) United States
(12) Patent Application Publication
(10) Pub. No.: US 2008/0165994 A1
(43) Pub. Date: Jul. 10, 2008

(54) Bluetooth enabled hearing aid

(75) Inventors: Barry Caren, Beverly Hills, CA (US); CM Wong, Ontario (CA)

Correspondence Address: PAUL, HASTINGS, JANOFSKY & WALKER LLP, 875 15th Street, NW, Washington, DC, 20005, US

(73) Assignee: MAGNADYNE CORPORATION, Compton, CA (US)

(21) Appl. No.: 11/809,517

(22) Filed: May 31, 2007

Related U.S. Application Data
(60) Provisional application No. 60/879,711, filed on Jan. 10, 2007.

(51) Int. Cl. H04R 25/00; H04B 7/00

(52) U.S. Cl. 381/312; 455/41.2

(57) ABSTRACT

Disclosed is a hearing aid device enabled with a Bluetooth transceiver, allowing the user to communicate with linked, Bluetooth enabled mobile radio or telephone. Mobile phone receives a communication, encodes it in accordance with the Bluetooth protocol and links with the transceiver, which is housed with the hearing aid. The system allows the hearing aid user to engage in a two way conversation through the hearing aid speaker.

### CROSS-REFERENCE TO RELATED APPLICATION

This application claims priority to co-pending United States provisional application entitled, “Bluetooth Enable Hearing Aid.” having Ser. No. 60/879711, having a filing date of Jan. 10, 2007, which application is entirely incorporated herein by reference.

### BACKGROUND

Field

The disclosed embodiments relate generally to the delivery of Bluetooth encoded audio signals to a user using a hearing aid device.

### SUMMARY

The disclosed embodiments present a hearing aid enabled with a local area receiver or transceiver configured for operation with a mobile communication device such as a mobile phone or radio. This allows the user to use the hearing aid device for its traditional amplification utility and further benefit form the device's enablement to automatically or selectively switch the audio feed to an incoming call received by the user's mobile phone or radio. As the call comes in and is engaged by the user, the phone's Bluetooth transceiver sends a signal, the hearing aid detects the signal and either selectively or automatically switches its audio input source from the microphone to the digital signal decoded and regenerated to an audio signal through its Bluetooth receiver. In another embodiment, the described device employs a mixer mixing the microphone signal and the audio signal decoded and regenerated through its Bluetooth receiver circuit. In another embodiment, one signal is attenuated with respect to the other. Yet in other embodiments the disclosed device comprises a microphone for return communication to the communication device.

Other devices, systems, methods, features and advantages of the embodiments will be or will become apparent to one having ordinary skill in the art upon examination of the following figures, detailed description and the claims. It is intended that all such additional systems, articles of manufacture, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the embodiments. In the figures, like reference numerals designate corresponding parts throughout the different views.

FIG. 1 illustrates a prior art mobile communication device (such as a mobile phone) and a prior art hearing aid;

FIG. 2 illustrates a representative diagram of an exemplary embodiment of the disclosed hearing aid configured for use with a mobile communication device, employing a switch to switch the microphone signal to the incoming signal;

FIG. 3 illustrates a representative diagram of an exemplary embodiment of the disclosed hearing aid configured for dual use of a single microphone to facilitate two-way communications;

FIG. 4 illustrates an alternate embodiment of the disclosed hearing aid configured for use with a mobile communication device, employing a mixer to mix the microphone signal with a local area signal; and

FIG. 5 illustrates a representative diagram of an exemplary embodiment of the disclosed hearing aid employing a mixer to mix the microphone signal and amplify the local area signal, configured for dual use of a single microphone to facilitate two-way communications.

### DETAILED DESCRIPTION

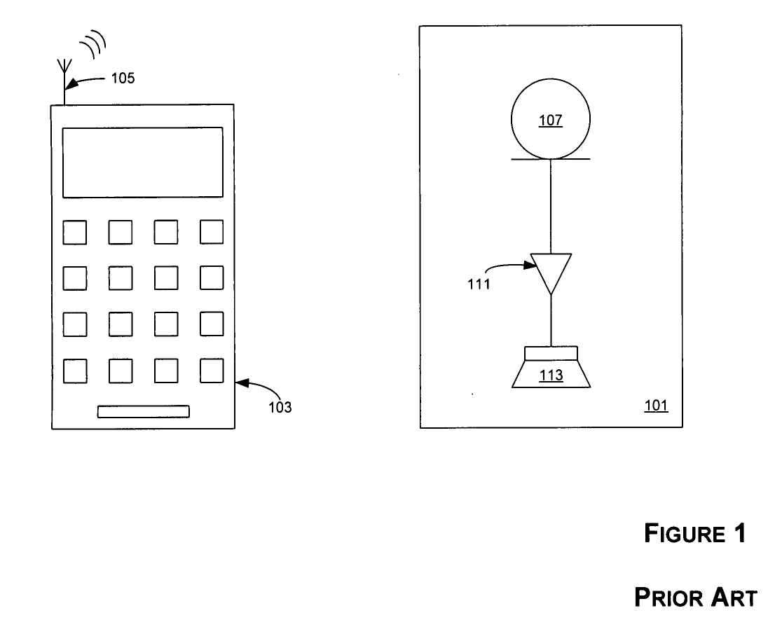

Shown in FIG. 1 is a typical, prior art hearing aid device comprising a microphone 107 configured to detect a frequency range in the band of human audio perception. Microphone 107 converts audio signals to electrical signals, which are coupled to the input of an amplifier 111. Amplifier 111 amplifies the signals and displays the same though an audio transducer 113. Accordingly device 101 amplifies and provides audio signals surrounding the user.

Also shown in FIG. 1 is a communications device 103 such as an appliance, computer, radio, mobile phone, microphone, television, video players (such as MPEG players), audio players (such as Ipod®, or MP3 players) and the like. Communication device 103 further employs a local area transceiver such as a transceiver compliant with the Bluetooth protocol, allowing device 103 to transmit and/or receive signals with another compatible unit via an antenna 105. One typical telecommunication device 103 is a mobile phone, such as a cell phone or a radio. However, telecommunication device 103 could also be a radio, land-wired telephone, or an appliance with integrated communication capabilities such as a computer as one example.

Bluetooth protocol is a low power, relatively short distance, wireless communication protocol standardized by the industry. It allows wireless communications between two or more devices. Once the device id is linked with a transmitter/transceiver, the two devices are enabled to communicate with each other, either in a one way or two way communications. The devices and methods described in this specification rely on local area communications. Although described in the context of the Bluetooth protocol, the reader will recognize that the same principles may be applied to adopt or use other standardized or proprietary local area network protocols. As such, reference to the Bluetooth protocol is not intended to be limiting, but exemplary.

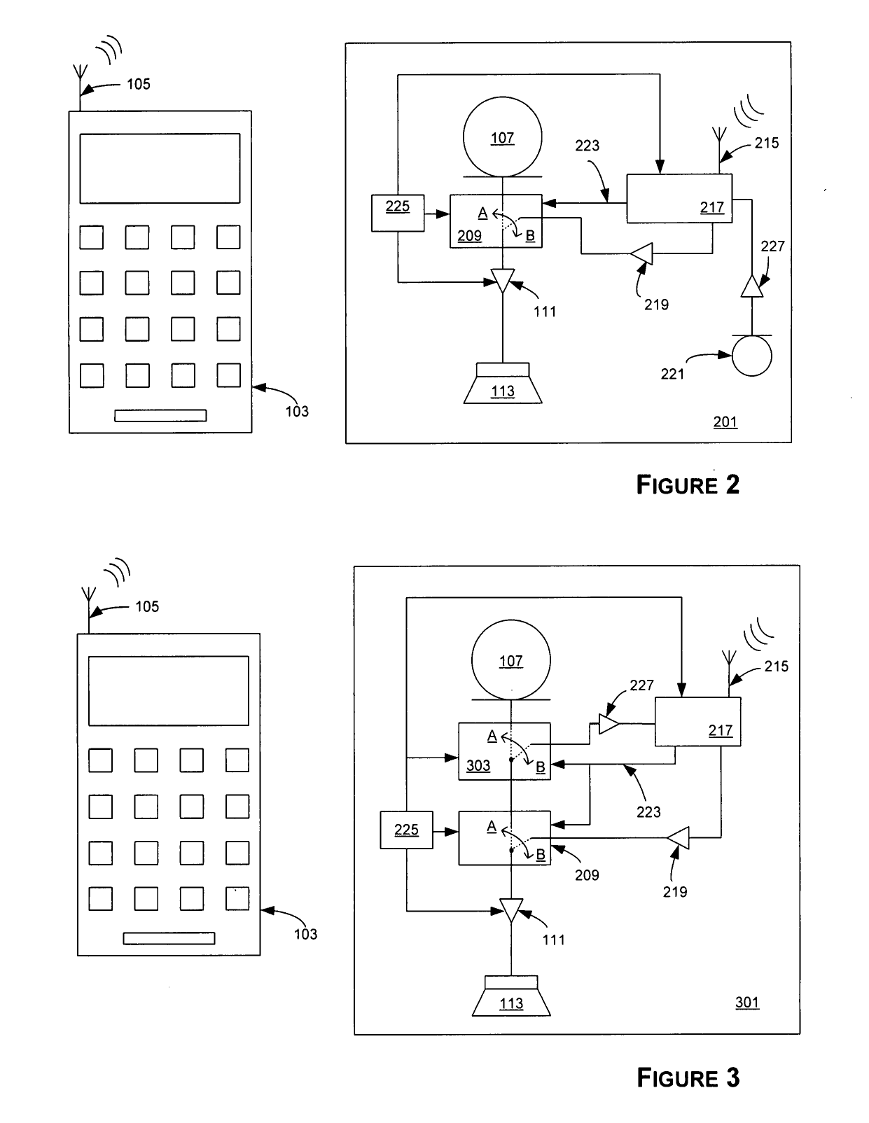

One of the disclosed embodiments provides a Bluetooth enabled hearing aid 201. FIG. 2 illustrates an exemplary embodiment of the described hearing aid 201 configured to work in a system comprising a communication device 103. The described hearing aid 201 comprises an antenna 215 configured to receive a local area signal, such as the ones following the Bluetooth protocol. In this embodiment, when a communication device 103 receives a call/communication, it encodes and transmits the received communication via antenna 105 as a Bluetooth signal, configured to reach one or more compatible devices, such as hearing aid 201. Note that in the case of Bluetooth compatible devices, they are typically linked together through an initial configuration.

Described hearing aid 201 is configured to normally function as a typical hearing aid, converting incoming audio signals to electrical signals (microphone signals) via microphone 107; signal passing through switch 209 in it's A position; amplifying the signal via amplifier 111 and displaying the signal through audio transducer 113. However, when a Bluetooth signal is detected via antenna 215 and decoder 217 determines that it is linked to the transmitter, the signal is decoded by decoder 217. The decoded digital bytes/words are then passed on to an audio digital-to-analog converter (DAC) 219. DAC 219 provides a decoded analog signal (decoder signal), which is selectively coupled to amplifier 111 via switch 209 in the B position controlled by decoder 217 via control line 223 or the user via a control 225. In the described embodiment, line 223 changes states in the presence of a Bluetooth communication linked to decoder 217, thereby controlling switch 209 to change from it's A position to its B position. Accordingly, the signals generated by the ambient audio detected by microphone 107 are shunned, or attenuated while signals decoded by decoder 217 are passed through, amplified and provided to transducer 113. One will also note that the embodiments described throughout illustrate and describe the switching functionality in a form of a switch. However, the same functionality may also be achieved vis-a-vis solid state devices, attenuators, mixers, software or other means of channeling a signal, while substantially attenuating or eliminating the other. And for example, throughout the embodiments described herein, in the embodiment where the microphone signal is attenuated with respect to the decoder signal, such attenuation could be preset to various levels, including without limitation −20 dB to −30 dB, which equals to about 3% to 10% of the original level.

Conversely, using the embodiment illustrated in FIG. 2, when the Bluetooth signal is terminated, decoder 217 via control line 223 causes switch 209 to switch from B position to A position, thereby switching amplifier 111 input back to the microphone signal from microphone 107. It is further notable that in this embodiment, the user receives the communication via the above described device 201 and communicates back via the microphone resident in communication device 103 or by some other means outside device 201.

Moreover, also shown in FIG. 2, is an alternate embodiment employing microphone 221 coupled to a transceiver, also designated as block 217, through a signal conditioner 227, which is functionally enabled in the presence of a Bluetooth communication with linked device 103. In this embodiment block 217 represents is a transceiver encoder/decoder, incorporating both receiving and transmitting functionality, allowing the user to receive and communicate audio signals to and from communication device 103. The functionality of conditioner 227 may be integrated into microphone 221 and/or transceiver 217, which in turn encodes the digitized signals generated by microphone 221 in accordance with the local area protocol (such as the Bluetooth protocol) and transmits it to device 103 via antenna 215. In this embodiment, hearing aid device 201 allows the user to listen and to communicate back to device 103.

FIG. 3 shows an alternative embodiment, employing microphone 107 in a dual role. When used in its conventional role, microphone 107 converts audio signals to electrical signals, which are then amplified via amplifier 111 and displayed via audio transducer 113. However, in this embodiment, microphone 107 can also be used in place of microphone 221 by providing microphone signals to transceiver 217. In the presence of a linked Bluetooth signal, line 223 (control) changes its state. When line 223 indicates the presence of a communication, switch 303 switches from position A to position B. As result, microphone 107 output, such as user's speech, is provided vis-a-vis switch 303, in its B position, to signal conditioner 227; and the conditioned signal is then provided to transceiver 217, which encodes the digitized microphone signal and transmits it to device 103. Control line 223 also directs switch 209 to swich from its A position to its B position, thereby directing the incoming signal from DAC 219 and transceiver 217 to amplifier 111 and to transducer 113. In the absence of a linked communication between devices 103 and 301, control line 223 changes its state and directs swiches 303 and 209 to switch to their respective A positions, thus allowing amplifier 111 to amplify microphone signals generated by microphone 107 and to display the amplified signal through audio transducer 113. Overall, this embodiment allows hearing aid 301 to function as a transceiver utilizing a single microphone element 107.

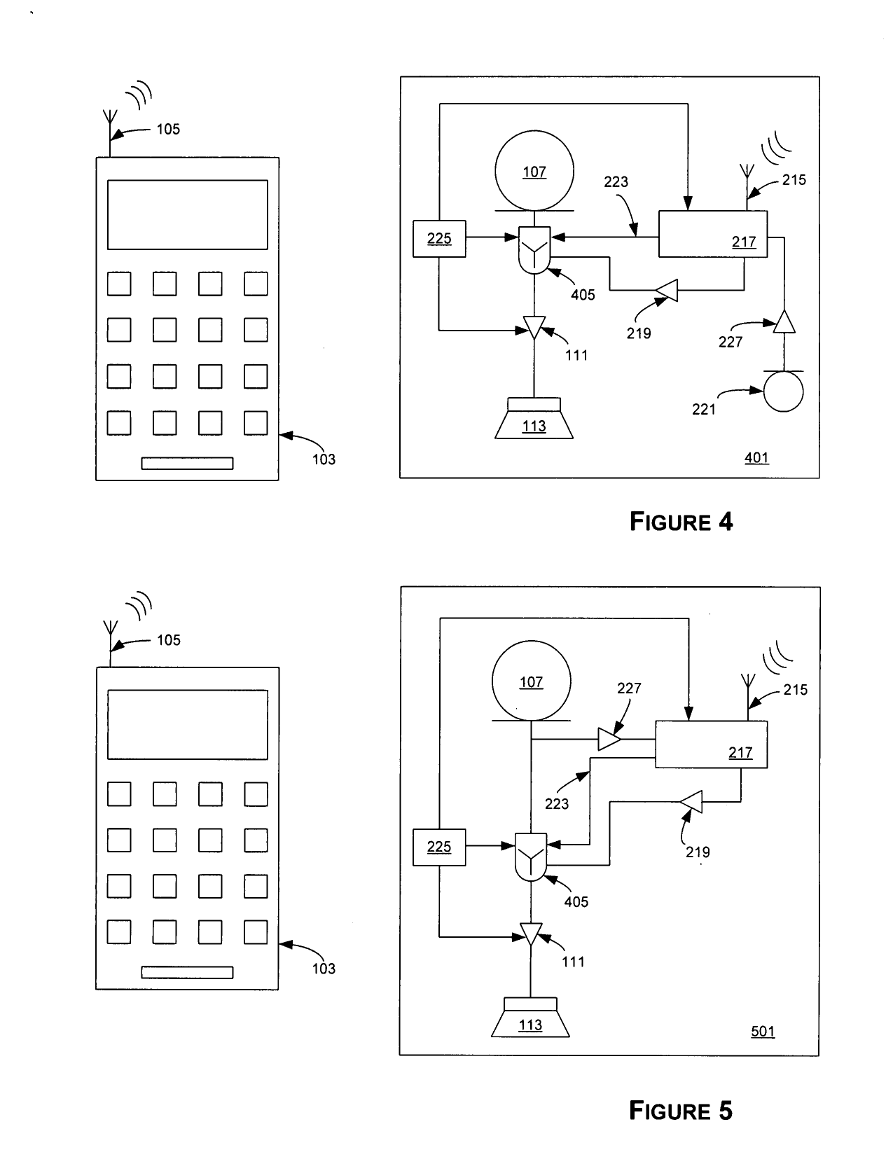

FIG. 4 illustrates an alternate embodiment of a hearing aid, as device 401. This embodiment seeks to mix the electrical signals produced by microphone 107 with incoming Bluetooth signals received by decoder 217 and converted through DAC 219. This embodiment allows the user to mix both signals. In one embodiment a mixer 405 is used to achieve the mixing function and it additionally may incorporate fixed or variable attenuation functionality controllable by a control 225. As in the above embodiments, a Bluettooth communication from device 103 is directed to decoder 217 via antenna 215. Once the Bluetooth communication is linked, the decoded signal is converted from its digital to an analog signal through digital to analog converter 219, which in turn provides the resulting analog signal to mixer 405. As decoder 217 receives a Bluetooth communication from linked device 103, it also causes mixer 405, via control line 223, to mix in the signal provided from DAC 219, to provide the resulting mixed signal at mixer 405 output that is then directed to amplifier 111 and audio transducer 113. The other signal mixed by mixer 405 is from microphone 107, which as before, converts audio signals to corresponding electrical signals. As above, in this embodiment device 401 is a receiver, employing the microphone of device 103 or some other means for back channel communications. The attenuation levels may vary, from single set values to multiple set values controllable in view of signal intensity, peak values or user control. In other embodiments, the attenuation settings are controlled by the user vis-a-vis control 225, either in steps, preset values or continuous control. Overall, however, the user is able to receive the incoming Bluetooth communication and also continue to receive audio signals from the surrounding environment.

In an alternate embodiment of device 401, two way communications are enabled by employing second microphone 221 and by using a transceiver, which as above is designated in this specification as the same functional block 217. In this embodiment, in the presence of a Bluetooth communication with linked device 103, signal conditioner 227 is functionally enabled, conditioning, amplifying and/or digitizing electrical signals produced by microphone 221 and providing the same to transceiver 217. Accordingly, audio signals produced by and/or about the user are conditioned and/or digitized by conditioner 227 and thereafter encoded and transmitted by transceiver 217 vis-a-vis antenna 215 to device 103. In the absence of a linked Bluetooth communication microphone signals provided by microphone 221 are functionally shunned.

An alternate embodiment shown in FIG. 5 provides for dual use of its microphone 107, facilitating two way communications via hearing aid 501 and replacing second microphone 221. In this embodiment the signal generated by microphone 107 is directed toward mixer/attenuator 405 and to transceiver 217 through signal conditioner 227. Transceiver 217 either enables signal conditioner 227 to operate or it alternatively accepts input from signal conditioner 227 in the presence of a linked Bluetooth signal.

In the absence of a linked Bluetooth signal, microphone 107 generates electrical signals that are channeled through mixer 405 to amplifier 111, where these signals are amplified and displayed through transducer 113. In the presence of a linked Bluetooth communication with a device 103, transceiver 217 decodes the signal, provides the decoded digital signal to DAC 219, which converts it to an analog decoder signal. Mixer 405 is enabled via control line 223, which changes states in the presence of a linked Bluetooth communication. Mixer 405 mixes the signal incoming from DAC 219 and from microphone 107 and provides the mixed signal to amplifier 111. Amplified signal is then displayed through audio transducer 113.

The above embodiments may be configured wherein mixer 405 attenuates the signal from microphone 107 to provide greater significance to the incoming signal from device 103. Also as described above, in an alternate embodiment control 225 allows for variable or fixed attenuation levels and other controls of mixer/attenuator 405 and/or amplifier 111.

In the presence of a linked communication with device 103, the signals provided by microphone 107 are also amplified and/or digitized by signal conditioner 227 and the resulting signal is encoded by transceiver 217 for transmission to device 103. Accordingly, as the user speaks, his/her voice is sensed by microphone 107 and is transmitted to device 103. This embodiment may be configured with the functionality described for switch 303 or as shown in FIG. 5, with the assumption that the path between microphone 107 and transceiver 217 is functionally shunned in the absence of a linked communication with device 103.

Embodiments heretofore described are shown with user control 225. Such control may be integrated into the hearing aid devices. Control 225 may be characterized by mechanical or soft on/off control, selection switch, or a variable attenuation control. The on/off functionality 225 is useful for having control of automatic functionality described above. For example, the user may choose not to hear or mute the incoming signal from either microphone(s) 107 or 221 or from decoder/transducer 217; or control the volume of the signal by adjusting the gain of amplifier 111. The attenuation control 225 is particularly useful for selecting either a preset level of attenuation by selecting or sequentially toggling through the choices, or in the alternative by variably selecting the proportionality of signal level of the incoming and surrounding audio signals.

Notably, throughout the described embodiments functional blocks are demonstrated for illustrative purposes. However, the functionality of these blocks may be achieved through different means. For example, all or some of the components may be integrated into one or more of the other components. For example, functionality of switch 209, amplifier 111, DAC 219, and/or signal conditioner 227 may be characterized by solid state device(s), or software implementation, which may be integrated into decoder/transceiver 217 or microphones 107 and/or 221 or any other functional block, whether illustrated herein or not. Nonetheless, the intended functionality and results would remain the same, whether achieved through static components, solid state components, and/or software.

While the present description has been described herein with reference to particular embodiments thereof, these have been described by way of example only, and not by limitation. A degree of latitude or modification, various changes and substitutions are intended in the foregoing disclosure. It will be appreciated that in some instances some features of the embodiments will be employed without corresponding use of other features without departing from the spirit and scope of the invention as set forth and It will be apparent to those of ordinary skill in the art that many alternative embodiments, applications and implementations are possible and are within the scope of this invention.

We claim:

1. An audio device comprising an audio transducer coupled to a switch; said switch configured to couple to said audio transducer at least one of a microphone signal and of a decoder signal, wherein said decoder signal is derived from a local area signal and provided by a decoder.

2. The device of claim I wherein said audio device is a hearing aid configured for fitment about a person's ear.

3. The device of claim 1 wherein said local area signal is a Bluetooth signal.

4. The device of claim 1 wherein said device is configured to communicate with a communication device configured for receiving a communication and rebroadcasting said communication as said local area signal configured for receipt by said decoder comprised by said audio device.

5. The device of claim 4 wherein said communication device is chosen from the group consisting of a radio, a microphone, a television, a video player, a gaming device, an audio player, a telephone, a mobile phone, a computer, an appliance.

1. An audio device comprising an audio transducer coupled to a switch; said switch configured to couple to said audio transducer at least one of a microphone signal and of a decoder signal, wherein said decoder signal is derived from a local area signal and provided by a decoder.

2. The device of claim 1 wherein said audio device is a hearing aid configured for fitment about a person's ear.

3. The device of claim 1 wherein said local area signal is a Bluetooth signal.

4. The device of claim 1 wherein said device is configured to communicate with a communication device configured for receiving a communication and rebroadcasting said communication as said local area signal configured for receipt by said decoder comprised by said audio device.

5. The device of claim 4 wherein said communication device is chosen from the group consisting of a radio, a microphone, a television, a video player, a gaming device, an audio player, a telephone, a mobile phone, a computer, an appliance.

6. The device of claim 1 further comprising a digital to analog converter coupled between said decoder and said audio transducer, said digital to analog converter configured to accept a digital decoder signal from said decoder and to convert said digital decoder signal to said decoder signal, wherein said decoder signal is in an analog form.

7. The device of claim I further comprising at least one amplifier for amplifying said at least one of said microphone signal and said decoder signal, thereby providing an amplified signal to said audio transducer.

8. The device of claim 1 further comprising a control for controlling at least one of a gain of said amplifier, said switch and said decoder functionality.

9. A system comprising: an audio transducer coupled to a switch; said switch configured to couple said audio transducer to at least one of a microphone signal, provided by a microphone, and of a decoder signal, provided by a decoder; wherein said decoder signal is decoded by said decoder from a local area signal transmitted from a communication device configured to receive a communication and rebroadcast said communication as said local area signal; and wherein said microphone, said decoder and said transducer are configured for fitment about a human ear.

10. The system of claim 9 wherein said local area signal is a Bluetooth signal.

11. The system of claim 9 wherein said communication device is chosen from the group consisting of a radio, a microphone, a television, a video player, a gaming device, an audio player, a telephone, a mobile phone, a computer, an appliance.

12. The system of claim 9 further comprising a digital to analog converter coupled between said decoder and said audio transducer, said digital to analog converter configured to accept a digital decoder signal from said decoder and to convert said digital decoder signal to said decoder signal, wherein said decoder signal is in an analog form.

13. The system of claim 9 further comprising at least one amplifier for amplifying said at least one of said microphone signal and said decoder signal, thereby providing an amplified signal to said audio transducer.

9. A system comprising: an audio transducer coupled to a switch; said switch configured to couple said audio transducer to at least one of a microphone signal, provided by a microphone, and of a decoder signal, provided by a decoder; wherein said decoder signal is decoded by said decoder from a local area signal transmitted from a communication device configured to receive a communication and rebroadcast said communication as said local area signal; and wherein said microphone, said decoder and said transducer are configured for fitment about a human ear.

10. The system of claim 9 wherein said local area signal is a Bluetooth signal.

11. The system of claim 9 wherein said communication device is chosen from the group consisting of a radio, a microphone, a television, a video player, a gaming device, an audio player, a telephone, a mobile phone, a computer, an appliance.

12. The system of claim 9 further comprising a digital to analog converter coupled between said decoder and said audio transducer, said digital to analog converter configured to accept a digital decoder signal from said decoder and to convert said digital decoder signal to said decoder signal, wherein said decoder signal is in an analog form.

13. The system of claim 9 further comprising at least one amplifier for amplifying said at least one of said microphone signal and said decoder signal, thereby providing an amplified signal to said audio transducer.

14. The system of claim 9 further comprising a control for controlling at least one of a gain of said amplifier, said switch, and functionality of said decoder.

15. A device comprising: decoding means for decoding a local area signal and providing a decoder signal and a microphone means for converting an audio signal and providing a microphone signal; a switch means for switching said microphone signal and said decoder signal to an audio transducer means for delivering said one of said microphone signal and said decoder signal to a user.

16. The device of claim 15 wherein said decoder means, microphone means, switch means and transducer means are configured in a device for fitment about a user's ear.

17. The device of claim 15 wherein said local area signal is a Bluetooth signal.

18. The device of claim 15 wherein said device is configured to communicate with a communication device means configured for receiving a communication and rebroadcasting said communication as said local area signal configured for receipt by said decoder means comprised by said audio device.

19. The device of claim 15 wherein said communication device means is chosen from the group consisting of a radio, a microphone, a television, a video player, a gaming device, an audio player, a telephone, a mobile phone, a computer, an appliance.

20. The device of claim 15 further comprising a digital to analog converter means for converting a digital decoder signal provided by said decoder means to a corresponding decoder signal, wherein said decoder signal is in an analog form; said digital to analog converter coupled between said decoder means and said audio transducer means.

21. The device of claim 15 further comprising at least one amplifier means for amplifying said at least one of said microphone signal and said decoder signal, thereby providing an amplified signal to said audio transducer means.

22. The device of claim 15 further comprising a control means for controlling at least one of a gain means for controlling gain of said amplifier, said switch means, and functionality of said decoder means.

23. An audio device comprising: an audio transducer coupled to a switch; said switch configured to couple to said audio transducer at least one of a first microphone signal and of a decoder signal, wherein said first microphone signal is provided by a first microphone and said decoder signal is provided by a digital to analog converter converting a digital decoder signal from its digital form to said decoder signal in its analog form; said digital to analog converter coupled to a transceiver configured to decode said digital decoder signal from a local area signal; and a second microphone configured to provide a return microphone signal in an analog form, said return microphone coupled to an analog to digital converter for converting said second microphone signal to a digitized return microphone signal, said analog to digital converter coupled to said transceiver, wherein said transceiver is configured to encode and broadcast said digitized return microphone signal.

24. The device of claim 23 wherein said audio device is a hearing aid configured for fitment about a person's ear.

25. The device of claim 23 wherein said local area signal is a Bluetooth signal.

26. The device of claim 23 wherein said audio device is configured to communicate with a communication device configured for receiving a communication and rebroadcasting said communication as said local area signal configured for receipt by said transceiver comprised by said audio device.

27. The device of claim 26 wherein said communication device is chosen from the group consisting of a radio, a microphone, a television, a video player, a gaming device, an audio player, a telephone, a mobile phone, a computer, an appliance.

28. The device of claim 23 further comprising at least one amplifier amplifying said at least one of said first microphone signal and said decoder signal prior to providing said at least one of said signals to said audio transducer.

29. The device of claim 23 further comprising a control for controlling at least one of a gain of said amplifier, said switch, said second microphone, and functionality of said transceiver.

30. An audio device configured to receive a local area signal from a communication device, said audio device comprising:
a) an audio transducer coupled to a second switch;
b) said second switch configured to couple said audio transducer to at least one of an output of a first switch and an output of a digital to analog converter coupled to a transceiver, wherein said digital to analog converter configured to convert a digital decoder signal provided by said transceiver, to a decoder signal in an analog form;
c) output of said first switch coupled to an input of said second switch and an input of said first switch coupled to a microphone configured to provide a microphone signal;
d) an analog to digital converter coupled to said first switch and an output of said analog to digital converter coupled to said transceiver, said analog to digital converter further configured to convert said microphone signal from its analog form to a digitized microphone signal at its output, wherein transceiver is configured to encode said digitized microphone signal and broadcast an encoded digitized microphone signal to said communications device;
e) wherein the presence of said local area signal, linked with said transceiver, said first switch and said second switch are configured to operate in their respective B-positions, thereby coupling said microphone signal to said analog to digital converter, and coupling said decoder signal to said audio transducer; and wherein the absence of said local area signal linked with said transceiver, said first switch and said second switch are configured to operate in their respective A-positions; and
f) a second microphone configured to provide a return microphone signal in an analog form, said second microphone coupled to an analog to digital converter for converting said return microphone signal to a digitized return microphone signal, said analog to digital converter coupled to said transceiver, wherein said transceiver is configured to encode and broadcast said digitized return microphone signal to at least one said communication device.

31. The device of claim 30 wherein said audio device is a hearing aid configured for fitment about a person's ear.

32. The device of claim 30 wherein said local area signal is a Bluetooth signal.

33. The device of claim 30 wherein said communication device is chosen from the group consisting of a radio, a microphone, a television, a video player, a gaming device, an audio player, a telephone, a mobile phone, a computer, an appliance.

34. The device of claim 30 further comprising at least one amplifier amplifying said at least one of said first microphone signal and said decoder signal prior to providing said at least one of said signals to said audio transducer.

35. The device of claim 30 further comprising a control for controlling at least one of a gain of said amplifier, at least on one of said switches, said second microphone, and functionality of said transceiver provided by a decoder.

36. An audio device comprising: an audio transducer coupled to a mixer; said mixer configured to couple to said audio transducer at least one of a microphone signal and of a decoder signal, wherein said decoder signal is derived from a local area signal.

37. The device of claim 36 wherein said audio device is a hearing aid configured for fitment about a person's ear.

38. The device of claim 36 wherein said local area signal is a Bluetooth signal.

39. The device of claim 36 wherein said device is configured to communicate with a communication device configured for receiving a communication and rebroadcasting said communication as said local area signal configured for receipt by said decoder comprised by said audio device.

40. The device of claim 36 wherein said communication device is chosen from the group consisting of a radio, a microphone, a television, a video player, a gaming device, an audio player, a telephone, a mobile phone, a computer, an appliance.

41. The device of claim 36 further comprising a digital to analog converter coupled between said decoder and said audio transducer, said digital to analog converter configured to accept a digital decoder signal from said decoder and to convert said digital decoder signal to said decoder signal, wherein said decoder signal is in an analog form.

42. The device of claim 36 further comprising at least one amplifier for amplifying said at least one of said microphone signal and said decoder signal, thereby providing an amplified signal to said audio transducer.

43. The device of claim 36 further comprising a control for controlling at least one of a gain of said amplifier, said mixer and said decoder functionality.

44. The device of claim 36 further comprising a control for controlling at least one of a gain of said amplifier, said mixer, and functionality of said transceiver.

45. The device of claim 36 wherein said mixer is configured to attenuate at least one of said microphone signal and said decoder signal; thereby providing greater significance of one of said signals to the user.

46. A system comprising: an audio transducer coupled to a mixer; said mixer configured to couple said audio transducer to at least one of a microphone signal, provided by a microphone, and of a decoder signal, provided by a decoder; wherein said decoder signal is decoded by said decoder from a local area signal transmitted from a communication device configured to receive a communication and rebroadcast said communication as said local area signal; and wherein said microphone, said decoder and said transducer are configured for fitment about a human ear.

47. The device of claim 46 wherein said local area signal is a Bluetooth signal.

48. The device of claim 46 wherein said communication device is chosen from the group consisting of a radio, a microphone, a television, a video player, a gaming device, an audio player, a telephone, a mobile phone, a computer, an appliance.

49. The device of claim 46 further comprising a digital to analog converter coupled between said decoder and said audio transducer, said digital to analog converter configured to accept a digital decoder signal from said decoder and to convert said digital decoder signal to said decoder signal, wherein said decoder signal is in an analog form.

50. The device of claim 46 further comprising at least one amplifier for amplifying said at least one of said microphone signal and said decoder signal, thereby providing an amplified signal to said audio transducer.

51. The device of claim 46 further comprising a control for controlling at least one of a gain of said amplifier, said mixer, and functionality of said decoder.

52. A device comprising: decoding means for decoding a local area signal and providing a decoder signal and a microphone means for converting an audio signal and providing a microphone signal; a mixer means for mixing said microphone signal and said decoder signal to an audio transducer means for delivering at least one of said microphone signal and said decoder signal to a user.

53. The device of claim 52 wherein said decoder means, microphone means, switch means and transducer means are configured in a device for fitment about a user's ear.

54. The device of claim 52 wherein said local area signal is a Bluetooth signal.

55. The device of claim 52 wherein said device is configured to communicate with a communication device means configured for receiving a communication and rebroadcasting said communication as said local area signal configured for receipt by said decoding means comprised by said audio device.

56. The device of claim 52 wherein said communication device means is chosen from the group consisting of a radio, a microphone, a television, a video player, a gaming device, an audio player, a telephone, a mobile phone, a computer, an appliance.

57. The device of claim 52 further comprising a digital to analog converter means for converting a digital decoder signal provided by said decoder means to a corresponding decoder signal, wherein said decoder signal is in an analog form; said digital to analog converter coupled between said decoder means and said audio transducer means.

58. The device of claim 52 further comprising at least one amplifier means for amplifying said at least one of said microphone signal and said decoder signal, thereby providing an amplified signal to said audio transducer means.

59. The device of claim 52 further comprising a control means for controlling at least one of a gain means for controlling gain of said amplifier, said mixer means, and functionality of said decoder means.

60. An audio device comprising: an audio transducer coupled to a mixer; said mixer configured to couple to said audio transducer at least one of a first microphone signal and of a decoder signal, wherein said first microphone signal is provided by a first microphone and said decoder signal is provided by a digital to analog converter converting a digital decoder signal from its digital form to said decoder signal in its analog form; said digital to analog converter coupled to a transceiver configured to decode said digital decoder signal in its digital form from a local area signal; and a second microphone configured to provide a return microphone signal in an analog form, said second microphone coupled to an analog to digital converter for converting said return microphone signal to a digitized return microphone signal, said analog to digital converter coupled to said transceiver, wherein said transceiver is configured to encode and broadcast said digitized return microphone signal.

61. The device of claim 60 wherein said audio device is a hearing aid configured for fitment about a person's ear.

62. The device of claim 60 wherein said local area signal is a Bluetooth signal.

63. The device of claim 60 wherein said device is configured to communicate with a communication device configured for receiving a communication and rebroadcasting said communication as said local area signal configured for receipt by said transceiver comprised by said audio device.

64. The device of claim 60 wherein said communication device is chosen from the group consisting of a radio, a microphone, a television, a video player, a gaming device, an audio player, a telephone, a mobile phone, a computer, an appliance.

65. The device of claim 60 further comprising at least one amplifier amplifying said at least one of said first microphone signal and said decoder signal prior to providing said at least one of said signals to said audio transducer.

66. The device of claim 60 further comprising a control for controlling at least one of a gain of said amplifier, said mixer, and functionality of said transceiver.

67. The device of claim 60 wherein said mixer is configured to attenuate at least one of said microphone signal and said decoder signal; thereby providing greater significance of one of said signals to the user.

68. The device of claim 60 wherein said mixer is configured to amplify one of said microphone signal and said decoder signal over the other; thereby providing greater significance of one of said signals to the user.

69. An audio device configured to receive a local area signal from a communication device said audio device comprising:
a) an audio transducer coupled to a mixer;
b) said mixer configured to couple said audio transducer to at least one of a microphone signal provided by a microphone and a decoder signal in an analog form provided by a digital to analog converter coupled to a transceiver;
c) said digital to analog converter configured to convert a digital decoder signal, provided by a transceiver, to said decoder signal in said analog form; and
d) an analog to digital converter coupled to said microphone and to said transceiver and configured to convert said microphone signal from its analog form as provided by said microphone to a digitized microphone signal, wherein said transceiver is configured to encode and broadcast said digitized microphone signal as said local area signal to at least one said communication device.

70. The device of claim 69 wherein said audio device is a hearing aid configured for fitment about a person's ear.

71. The device of claim 69 wherein said local area signal is a Bluetooth signal.

72. The device of claim 69 wherein said communication device is chosen from the group consisting of a radio, a microphone, a television, a video player, a gaming device, an audio player, a telephone, a mobile phone, a computer, an appliance.

73. The device of claim 69 further comprising at least one amplifier amplifying said at least one of said first microphone signal and said decoder signal prior to providing said at least one of said signals to said audio transducer.

74. The device of claim 69 further comprising a control for controlling at least one of a gain of said amplifier, said mixer, said second microphone, and functionality of said transceiver.

75. The device of claim 69 wherein said mixer is configured to attenuate at least one of said microphone signal and said decoder signal; thereby providing greater significance of one of said signals to the user.

76. The device of claim 69 wherein said mixer is configured to amplify one of said microphone signal and said decoder signal over the other; thereby providing greater significance of one of said signals to the user.
